(19) United States
(12) Patent Application Publication
(10) Pub. No.: US 2012/0293073 A1
(43) Pub. Date: Nov. 22, 2012

(54) APPARATUS FOR DRIVING A GAS DISCHARGE LAMP

(75) Inventors: Edwin Theodorus Maria De Koning, Eindhoven (NL); Bennie Simpelaar, Lommel (BE); Joris Hubertus Antonius Hagelaar, Eindhoven (NL); Lars Dabringhausen, Aachen (DE)

(73) Assignee: KONINKLIJKE PHILIPS ELECTRONICS N.V., Eindhoven (NL)

(21) Appl. No.: 13/519,150

(22) PCT Filed: Nov. 29, 2010
(86) PCT No.: PCT/IB2010/055476

§ 371 Date: Jun. 26, 2012

(30) Foreign Application Priority Data
Dec. 30, 2009 (EP) 09180978.0

(51) Int. Cl. H05B 41/36; H05B 41/30

(52) U.S. Cl. 315/129; 315/224

(57) ABSTRACT

A method of generating a measuring signal indicating arc straightness in a gas discharge lamp (L) comprises the following steps: in a first step, applying a first lamp current (IN) to the lamp; in a second step, adding a brief pulse current (Ip) to the first lamp current (IN), allowing the lamp voltage to regain a steady state, and measuring the resulting average value of the lamp voltage (V2) in this steady state; generating a measuring signal indicating arc straightness on the basis of said average lamp voltage (V2) measured in the second step.

### FIELD OF THE INVENTION

The present invention relates in general to gas discharge lamps, more particularly high-pressure or high-intensity discharge lamps. Specifically, the present invention relates to Xenon lamps used in the automotive field.

### BACKGROUND OF THE INVENTION

As gas discharge lamps are well known, a description thereof will be kept brief. Generally speaking, such lamps comprise a vessel, typically of quartz, enclosing a chamber with a suitable filling and two electrodes arranged opposite each other, penetrating the vessel wall and extending into the chamber. Using a high voltage ignition, a breakdown can occur in the gas filling, causing a plasma arc discharge between the two electrodes. It is a problem that the electric arc can assume a curved shape (“bowing” of the arc). In vertical operation, bowing can occur due to Lorentz forces of the lamp construction. When the lamp is in a horizontal position, i.e. when the arc is directed horizontally, as is typical in automotive Xenon lamps, bowing is due to, inter alia, gravity and convection: the plasma is hotter than its surroundings and tends to shift upwards. The vessel wall will stabilize the arc, but contact between arc plasma and vessel wall is undesirable, as this may shorten the lifetime of the lamp.

In both situations, i.e. horizontal operation as well as vertical operation, arc straightening is a solution for longer lamp life and/or for obtaining better technical properties of the lamp. Since gas discharge lamps as well as the problem of arc curving are known per se, a more detailed explanation is omitted here.

### SUMMARY OF THE INVENTION

It is already known that arc straightening is possible by inducing high-frequency components in the lamp current. However, for this technique, a problem is to find an optimal or even suitable operating frequency. The exact frequencies that achieve arc straightening are not the same for different lamp types, and may even differ for different lamps of the same type, for instance due to production tolerances, ageing, etc. Further, high-frequency current components may give rise to undesirable acoustic resonances, and again the exact frequencies that cause acoustic resonances are not the same for different lamp types and may even differ for different lamps of the same type. Thus, it is problematic to design a lamp driver such that it adds a high-frequency current ripple component which will achieve advantageous arc-straightening without causing disadvantageous acoustic resonances.

It is an objective of the present invention to overcome or at least reduce the above problems.

In view of the above-mentioned problems, it is not possible to design a driver such that it has a fixed setting for the high-frequency current ripple parameters. Therefore, in an electronic driver according to the present invention, the ripple frequency and/or the ripple amplitude are controllable, and a control device sets these parameters according to a trial-and-error method, i.e. the control device makes amendments to these parameters and monitors the arc straightness to see what the effect is of the amendment made. If the amendment results in an increased arc curvature, the amendment is not an improvement and is rejected. Thus, by trial and error, the control device can find an improvement for the setting of the ripple parameters, and the control device can even find the optimum setting of these parameters where the arc curvature has a minimum value; it being noted that there is no guarantee that this minimum value is zero.

In such a trial and error method, there clearly is a need for a feedback mechanism, wherein a measuring signal indicating the arc straightness or arc curvature is obtained and provided to the control device. After all, whatever the parameter varied by the control device and whatever the algorithm used in this variation, the control device needs to “see” the result of its trials. It would be possible to use an optical sensor to actually “look” at the arc; such an approach has already been proposed in WO2008/099329, but has the disadvantage of being complicated: it is much more preferred to monitor the electric behavior of the lamp.

WO2008/099329 also proposes to monitor the lamp voltage: a lower voltage indicates a straighter arc. The method disclosed in this document is based on the assumption that lamp voltage is proportional to arc length, so that increased arc curvature results in increased lamp voltage.

The present invention aims to provide an alternative method of providing a measuring signal indicating arc straightness or arc curvature, which method does not require the above assumption to be true.

To this end, the present invention proposes to apply a brief current peak to the lamp current, and to monitor the ratio between lamp voltage during this current peak and lamp voltage before/after this current peak. It is noted that the peak can have a positive or a negative value, corresponding to a brief increase or decrease, respectively, of the current. Further advantageous elaborations are mentioned in the dependent claims.

### BRIEF DESCRIPTION OF THE DRAWINGS

These and other aspects, features and advantages of the present invention will be further explained by means of the following description of one or more preferred embodiments with reference to the drawings, in which same reference numerals indicate same or similar parts, and in which:

FIG. 1 is a block diagram schematically showing an electronic driver for driving a gas discharge lamp;

FIG. 2 is a graph illustrating low-frequency square wave lamp current with a high-frequency ripple superimposed thereon;

FIG. 3 is a graph illustrating the lamp current with a measuring current pulse superimposed thereon, and the corresponding lamp voltage;

FIG. 4A is a graph comparable to FIG. 2, illustrating Frequency Shift Keying (FSK) operation;

FIG. 4B is a graph comparable to FIG. 4A, illustrating the invention applied in a case of FSK operation;

FIG. 5A is a graph comparable to FIG. 2, illustrating duty cycle operation with magnetic arc straightening;

FIG. 5B is a graph comparable to FIG. 5A, illustrating the invention applied in a case of duty cycle operation with magnetic arc straightening.

### DETAILED DESCRIPTION OF THE INVENTION

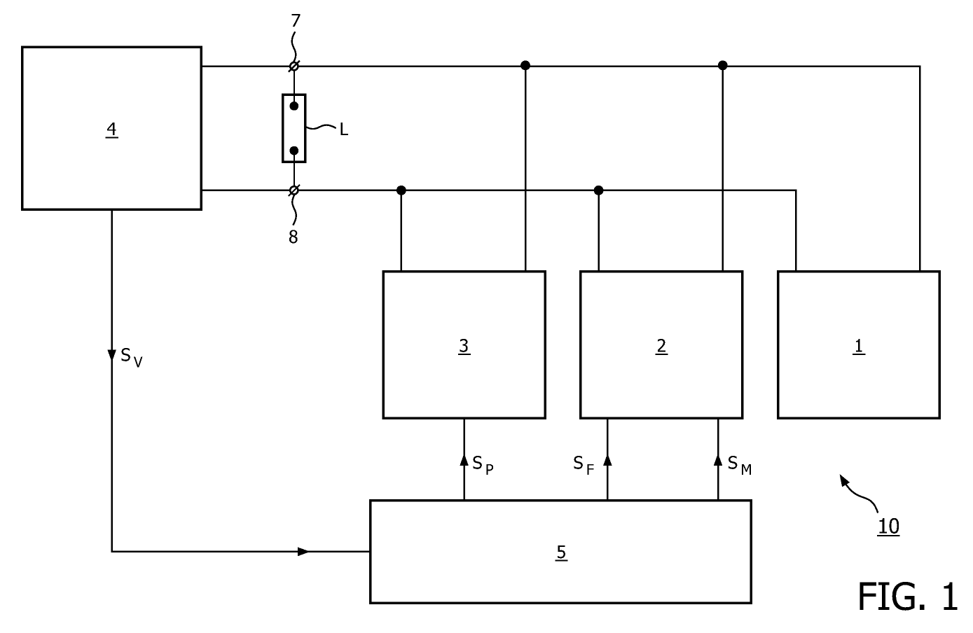

FIG. 1 is a block diagram schematically showing an exemplary embodiment of an electronic driver 10 for driving a gas discharge lamp L. The driver 10 has output terminals 7, 8 for receiving a lamp and connection to the lamp electrodes. The lamp L is of a type having two electrodes opposite each other in a sealed chamber. In a specific embodiment, the lamp is a Xenon discharge lamp for application in automotive. During operation, a discharge is maintained within the chamber, which discharge is indicated as an electric arc.

In the electronic lamp driver according to the present invention, the current applied to the lamp can be considered as containing three mutually independent current components, for which reason the following explanation illustratively assumes that the lamp driver comprises three functionally independent current sources having their output terminals coupled in parallel to the device output terminals 7, 8, so that the lamp L receives the summation of the three current components from the three current sources. A first current source 1, hereinafter also indicated as main current source, provides a first current component indicated as the main or basic lamp current. Depending on, for instance, lamp type, type of application of the lamp, designer's preference, etc, this main lamp current may be a DC current, a commutating DC current, a sine-shaped current, a triangular current, etc. In an illustrative and preferred embodiment, the main lamp current is a commutating DC current, also indicated as low-frequency square wave current. In the case of a commutating DC current, the duty cycle may be 50% but it is also possible that the duty cycle is varied. The choice of the waveform of the main lamp current is not relevant for understanding the present invention. Since current sources for generating lamp current having a desired waveform are known per se, a detailed discussion of design and operation of the main current source 1 is omitted here.

A second current source 2, hereinafter also indicated as secondary current source, provides a second current component that will also be indicated as secondary current or ripple current, which secondary current may be for instance sine-shaped or triangular or square-wave. Since current sources capable of generating a ripple lamp current for arc straightening purposes are known per se, a detailed discussion of design and operation of the secondary current source 2 is omitted here.

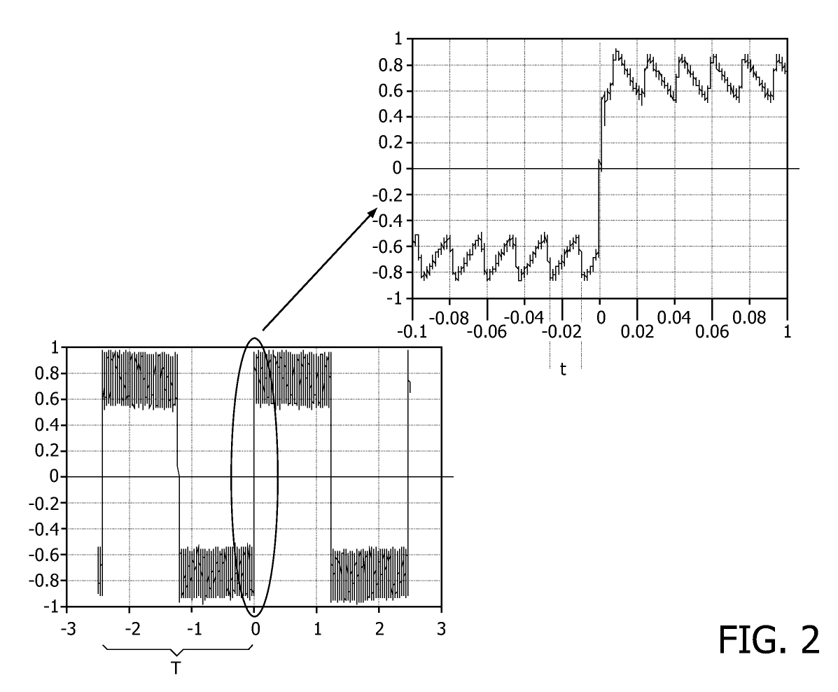

The frequency of the ripple current is substantially higher than the frequency of the main lamp current (which frequency is considered zero in the case of DC current), so, in the case of a commutating DC current, the sum-current is a square wave with a ripple superimposed thereon, as illustrated in FIG. 2. The period of the low-frequency square wave current is indicated as T, while the period of the high-frequency ripple current component is indicated as t. It is noted that it is possible that the low-frequency main current source 1 and the high-frequency secondary current source 2 are integrated as one combined current source, designed such as to generate low-frequency current of which the amplitude varies at a high frequency.

A third current source 3, hereinafter also indicated as pulse current source, provides a third current component that will also be indicated as pulse current. This pulse current has a substantially square waveform, i.e. it is normally zero but for a brief duration t_{P}, substantially longer than t and substantially smaller than T, it has a constant non-zero value. It is possible that the third current source 3 produces its current pulse once (or even more times) during each period T of the low-frequency square wave current.

The design illustrated in FIG. 1 is an exemplary embodiment only. Instead of three separate current sources connected in parallel, different designs are possible. For instance, instead of a parallel connection of the current sources, a series connection is possible. Further, instead of a parallel connection of the output terminals, it is also possible that a coupling transformer is used.

Further, the three current sources may be integrated; for instance, the driver may have a half-bridge or full-bridge topology, as known per se. In that case, the ripple current component and the commutation of the main current component can be controlled by a suitable timing of the bridge transistors. It is also possible that use is made of one controllable current source, of which the current magnitude can be varied at a high frequency on the basis of an input control signal, and that such input control signal is generated by the software of a control device.

The second and third current sources 2 and 3 are controllable current sources, and the driver 10 further comprises a control device 5, for instance a suitably programmed microcontroller, for generating a control signal Sp for controlling the third current source 3 and for generating control signals Sf and Sm for controlling the second current source 2; in the following, this control device will simply be indicated as “controller”. Alternatively, it is possible that the third current source 3 is integrated with the main current source 1, or that the main current source 1 is a controllable current source, and that the controller 5 controls the magnitude of the output current of the main current source 1 such as to temporarily increase or decrease the main current, but in the exemplary embodiment discussed here, the main current source 1 has a fixed setting. In this exemplary embodiment of this discussion, the main current may be a commutating DC current, in which case the commutation frequency and the current magnitude are fixed. Typically, the commutation frequency may be in the range of 275 Hz-750 Hz, while a commutation frequency is typically in the order of about 400 Hz. Depending on lamp type, a typical lamp voltage is in the order of about 45 V; then, for the case of a 35 W lamp, the lamp current magnitude is about 0.78 A.

As regards the ripple current, this typically has a ripple frequency in the range from 1 kHz to 100 kHz. The secondary current source 2 is a controllable current source, and the controller 5 controls ripple parameters of the ripple current. For instance, the ripple frequency is dependent on a control signal Sf from the controller 5, and/or the amplitude of the ripple current or modulation depth is dependent on a control signal Sm from the controller 5. It is noted that the amplitude of the ripple current is expressed as a modulation depth M, defined as the amplitude of the ripple current divided by the amplitude of the main current. Typically, the modulation depth M is in the range from 0 to 40%.

Apart from ripple frequency and modulation depth, the ripple current may have some further characteristic features. For instance, the frequency of the ripple current may be swept in a sweep range from a lower frequency limit to an upper frequency limit, in which case the sweep frequency, the sweep range, the sweep form (triangular, sine-shaped, etc) are further parameters. In principle, it is possible that these parameters are also controlled by the controller 5, in which case an optimization with respect to these parameters can also be executed by the controller 5 similar to the optimization that will be discussed in the following. However, in the embodiment that is preferred in view of its design simplicity, these parameters are fixed in accordance with predetermined design considerations. It is noted that these parameters may have an influence on the eventual setting of the controller 5 in the sense that a different setting of said fixed parameters may lead to a different control setting by the controller 5, but said fixed parameters are no input parameters to the controller; they are taken for granted. In the following discussion, therefore, said fixed parameters will be ignored.

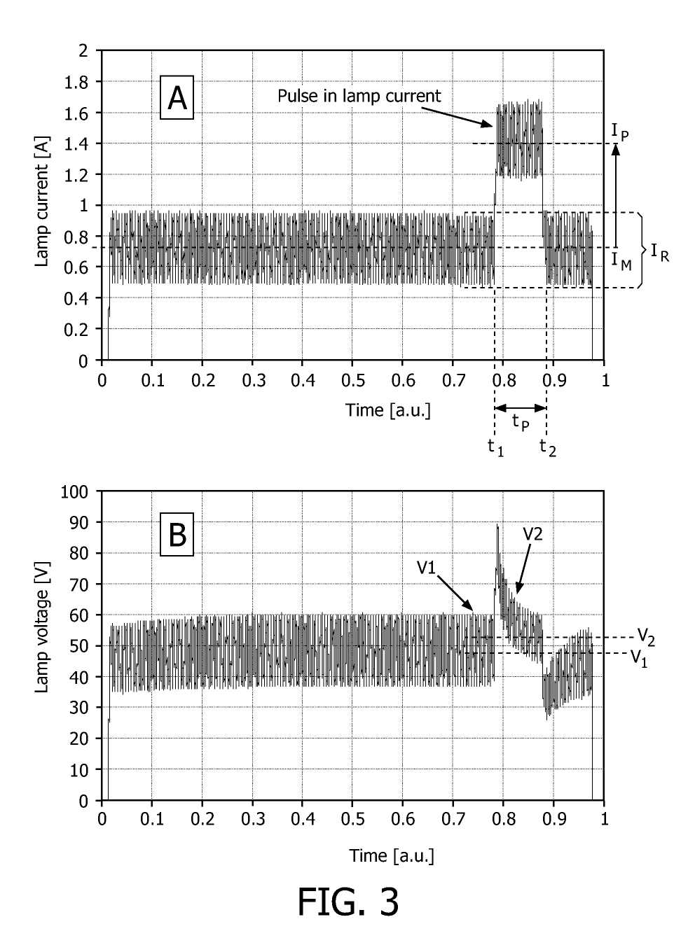

FIG. 3 shows graphs on a time scale larger than the pulse duration t_{P} but smaller than the main current period T. Graph A shows lamp current. With reference to the above explanation, the “normal” current I_{N} consists of the superposition of the main current I_{M} from the first current generator 1 and the ripple current I_{R} from the second current generator 2. The main current I_{M} is a constant current level of about 0.7 A. The ripple current I_{R} is a high-frequency current ripple having an amplitude of about 0.2 A. For obtaining a measuring signal indicating the arc shape, the current pulse I_{P} from the third current source 3 is superimposed onto the “normal” current background from time t1 to t2. The current pulse I_{P} in the example shown has a constant current magnitude of about 0.7 A, and has a duration t_{P}=t2−t1. It is noted that the timing t1, t2 of this current pulse, as well as the pulse magnitude, are controlled by the pulse control signal S_{P} from the controller 5. The precise timing of the current pulse is not critical, but in the case of commutating DC current it is preferred that the current pulse is timed shortly before a commutation moment, as shown.

The driver 10 further comprises a lamp voltage sensor 4, having input terminals coupled to the lamp electrodes and providing a measuring signal S_{V} to the controller 5 indicating the measured lamp voltage. Graph B in FIG. 3 shows the measured lamp voltage. It can be seen that, associated with the “normal” current, the lamp voltage is a substantially constant “normal” voltage V1 of about 47 V with a voltage ripple of about 12 V superimposed thereon. In response to the current step increase at t1, the lamp voltage increases stepwise, and likewise, in response to the current step decrease at t2, the lamp voltage decreases stepwise. In the time frame from t1 to t2, while the lamp current remains constant, the lamp voltage more or less exponentially falls back to regain a steady state in which the voltage level V2 is higher than V1.

It is believed that the explanation for this behavior is as follows. Immediately after the stepwise current increase, there is a stepwise increase in the voltage corresponding to an increase in the cathode drop. Somewhat later, the increased heat development causes a rise of the temperature of the electrode and hence a lowering of the cathode drop, while the increased heat development further causes a rise of the plasma temperature, hence an increase of the plasma conductivity and hence a lowering of the plasma voltage. After a little while, the temperature remains constant and hence the voltage remains constant.

With respect to the above behavior, it is believed that it is influenced by the position of the arc in the following manner, If the arc is curved, the distance between arc and vessel wall is reduced, thus there is increased heat transfer between arc plasma and vessel wall: increasing the plasma temperature takes more time, and the temperature finally reached by the plasma is lower; consequently, the final lamp voltage is higher. Conversely, in the case of a straight arc, the plasma more quickly reaches a higher temperature, thus the lamp voltage is lower.

Thus, the inventor has found that the steady state value V2 reached by the lamp voltage is a good indicator of the arc shape, or, in other words, of the arc curvature or, conversely, arc straightness. An elegant way of expressing this steady state value by a dimensionless parameter is calculating the ratio R=V2/V1; this dimensionless parameter is not dependent any more on the constant “normal” voltage V1.

During operation of the lamp, the control device 5 selects a first value X1 for a parameter to be optimized, for instance the frequency of the high-frequency current ripple, applies a current pulse, and measures the voltage response parameter R for this first value X1, which is expressed as R1(X1). Then, the control device 5 selects a second value X2 for this parameter to be optimized, applies a current pulse, and measures the voltage response parameter R for this second value X2, which is expressed as R2(X2). If R2 is less than R1, then X2 is a better operating value for the parameter than X1, or vice versa. It should be clear to a person skilled in the art that it is thus possible to find optimal parameter values where R has the smallest value.

Thus, it can be seen that the method proposed by the present invention utilizes the thermal resistance between the arc plasma and the vessel wall. Consequently, the method proposed by the present invention works better if the thermal interaction between plasma and vessel wall is stronger. Thus, the method proposed by the present invention works better for smaller lamps as compared to larger lamps. Further, the method proposed by the present invention works less well if the gas filling of the vessel is a good thermal insulator: thus, if the gas filling contains more of an insulating component such as mercury, the method proposed by the present invention works less well.

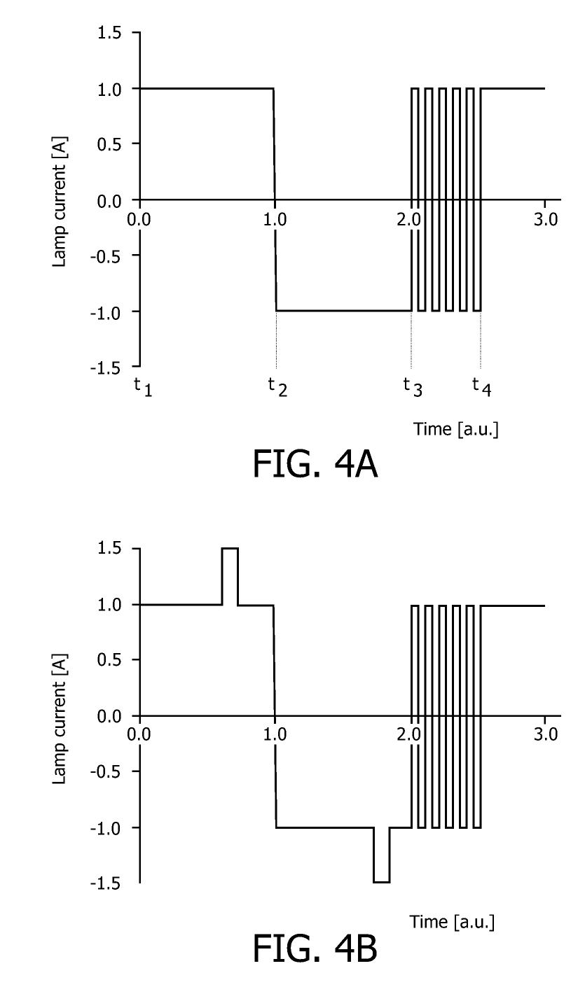

In the above, the invention was explained for an embodiment where the HF current component for arc straightening and the LF main current component are provided to the lamp simultaneously. However, the present invention can also be implemented when the HF current component for arc straightening and the LF main current component are provided to the lamp in an alternating manner. FIG. 4A is a graph comparable to FIG. 2, schematically showing lamp current as a function of time, for an exemplary embodiment where the lamp current always has the same magnitude. From time t1 to t3, the current alternates at a relatively low frequency. More particularly, from time t1 to t2, the current has a first direction (shown as positive current) while from time t2 to t3 the current has the opposite direction (shown as negative current). The duration (t2−t1) is equal to the duration (t3−t2). Then, from time t3 to t4, the current alternates at a relatively high frequency. The above pattern is repeated, i.e. periods of high-frequency current and periods of low-frequency current alternate with each other. Such a current pattern is suitable for operating a lamp and inducing arc straightening. Since the lamp current is always constant while the frequency is alternated between a low value and a high value, such an operating scheme is also indicated as Frequency Shift Keying (FSK) operation. It is noted that the exact timing and/or frequency of the FSK periods may depend on lamp type.

FIG. 4B is a graph comparable to FIG. 4A, showing the current when the method according to the present invention is implemented. During a period of low-frequency current, i.e. either between t1 and t2 or between t2 and t3, or both (as shown), a brief current pulse is added to the otherwise constant current. The response by the lamp voltage is comparable to the response illustrated in FIG. 3, except of course for the high-frequency component in FIG. 3. Parameters that can be varied in order to optimize arc straightening are for instance the frequency of the high-frequency current during the third period from time t3 to t4, or for instance the timing and/or relative duration of this third period.

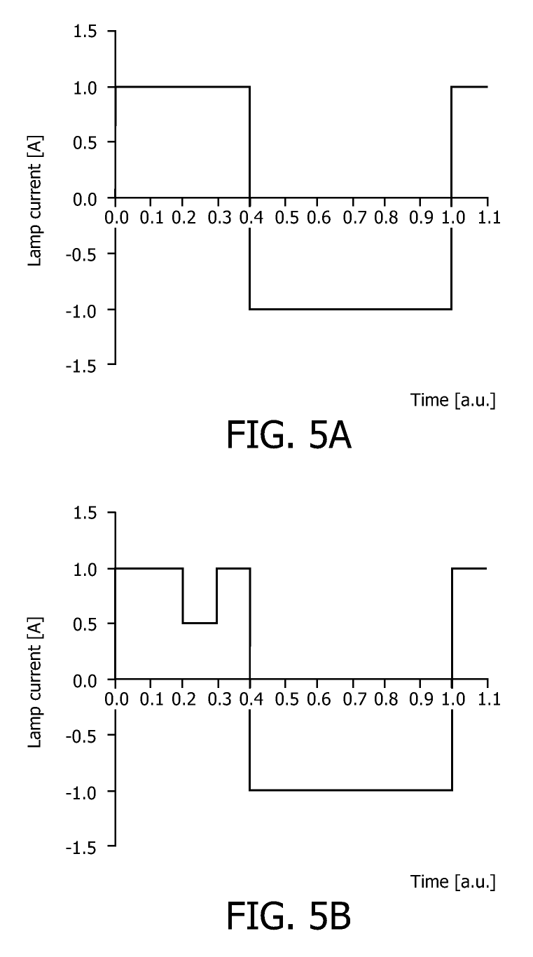

Measures for effecting arc straightening do not necessarily need to include high-frequency current components. The present invention is, in principle, applicable in combination with any of such measures. In one example, arc straightening is effected by arranging a magnet close to the lamp, and by operating the lamp with low-frequency square wave current of which the duty cycle is controlled. FIG. 5A is a graph comparable to FIG. 4A, schematically showing lamp current as a function of time for such a case. In the graph, the duty cycle would be 0.4. Arc straightening results from the fact that the lamp current on average has an offset that cooperates with the magnetic field to exert a net force to compensate for the gravity forces on the arc.

FIG. 5B is a graph comparable to FIG. 5A, showing the current when the method according to the present invention is implemented. During a period of positive current (as shown), or during a period of negative current, or both, a brief current pulse is added to the otherwise constant current. The response by the lamp voltage is comparable to the response illustrated in FIG. 3, except of course for the high-frequency component in FIG. 3. In order to optimize arc straightening, it is for instance possible to vary the duty cycle.

Summarizing, the present invention provides a method of generating a measuring signal indicating arc straightness in a gas discharge lamp L, the method comprising the following steps:

in a first step, applying a first lamp current I_{N} to the lamp;

in a second step, adding a brief pulse current I_{P} to the first lamp current I_{N}, allowing the lamp voltage to regain a steady state, and measuring the resulting average value of the lamp voltage V2 in this steady state;

generating a measuring signal indicating arc straightness on the basis of said average lamp voltage V2 measured in the second step.

While the invention has been illustrated and described in detail in the drawings and foregoing description, it should be clear to a person skilled in the art that such illustration and description are to be considered illustrative or exemplary and not restrictive. The invention is not limited to the disclosed embodiments; rather, several variations and modifications are possible within the protective scope of the invention as defined in the appending claims.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. Any reference signs in the claims should not be construed as limiting the scope.

In the above, the present invention has been explained with reference to block diagrams, which illustrate functional blocks of the device according to the present invention. It is to be understood that one or more of these functional blocks may be implemented in hardware, where the function of such functional blocks is performed by individual hardware components, but it is also possible that one or more of these functional blocks are implemented in software, so that the function of such functional blocks is performed by one or more program lines of a computer program or a programmable device such as a microprocessor, microcontroller, digital signal processor, etc.

1. Method of generating a measuring signal indicating arc straightness in a gas discharge lamp (L), the method comprising the following steps:
in a first step, applying a first lamp current (I_{N}) to the lamp;
in a second step, adding a brief pulse current (I_{P}) to the first lamp current (I_{N}), allowing the lamp voltage to regain a steady state, and measuring the resulting average value of the lamp voltage (V2) in this steady state;
generating a measuring signal indicating arc straightness on the basis of said average lamp voltage (V2) measured in the second step.

2. Method according to claim 1, wherein in the first step the resulting average value of the lamp voltage (V1) is measured, wherein the ratio (R=V1/V2) between the average lamp voltage (V1) measured in the first step and the average lamp voltage (V2) measured in the second step is calculated, and wherein the measuring signal indicating arc straightness is calculated on the basis of said ratio.

3. Method of operating a gas discharge lamp (L), the method comprising the steps of:
applying lamp current (I_{N}) to the lamp while performing an arc straightening measure with at least one variable parameter;
setting a first value (X1) for said variable parameter, and measuring arc straightness for this first value (X1);
setting a second value (X2) for said variable parameter, and measuring arc straightness for this second value (X2), using the method of claim 1;
calculating an optimum setting for said variable parameter on the basis of the measurement results thus obtained.

4. Method according to claim 3, wherein the lamp current (I_{N}) includes a constant current.

5. Method according to claim 3, wherein the lamp current (I_{N}) includes a low-frequency square wave current (I_{M}), and wherein the brief pulse current (I_{P}) is applied while the current direction remains constant.

6. Method according to claim 5, wherein the arc straightening measure includes applying to the lamp a high-frequency ripple component (I_{R}) superimposed on the low-frequency square wave current.

7. Method according to claim 3, wherein the lamp current includes a low-frequency square wave current, wherein the arc straightening measure includes applying to the lamp a high-frequency current alternating with the low-frequency square wave current, and wherein the brief pulse current (I_{P}) is applied, coinciding with the low-frequency square wave current, during a portion of time while the current direction remains constant.

8. Method according to claim 3, wherein the lamp current includes a low-frequency square wave current, wherein the arc straightening measure includes subjecting the arc to an external magnetic field and varying the duty cycle of the low-frequency square wave current, and wherein the brief pulse current (I_{P}) is applied a portion of time while the current direction remains constant.

9. Lamp driver (10) for driving a gas discharge lamp (L), particularly a Xenon lamp, the driver comprising:
output terminals (7, 8) for connecting to lamp electrodes of the lamp (L);
controllable current generating means (1, 2, 3) capable of providing at the output (7, 8) a normal lamp current (I_{N}) and a switchable pulse current (I_{P}) component;
controllable means for straightening the arc;
a control device (5) for controlling the current generating means (1, 2, 3) and for controlling the arc straightening means such as to vary one or more parameters of the arc straightening means and such as to switch the pulse current (I_{P}) component ON (t1) and OFF (t2);
a voltage sensor (4) coupled to the output terminals (7, 8) for measuring lamp voltage and providing a lamp voltage measuring signal (Sᵥ) to the control device (5);
wherein the control device (5) is designed:
to drive the lamp in at least two different parameter settings of at least one parameter of the arc straightening means,
in each parameter setting, to generate a measuring signal (S_{V}) indicating arc straightness in the lamp (L), using the method of claim 1,
to select an optimum setting of the at least one parameter on the basis of the measuring results.

10. Driver according to claim 9, wherein the control device (5) is designed to perform the lamp operating method.
